(19) United States
(12) Patent Application Publication
(10) Pub. No.: US 2014/0358374 A1
(43) Pub. Date: Dec. 4, 2014

(54) METHOD AND APPARATUS FOR CONTROLLING STEERING WHEN FAILURE OCCURS IN MOTOR POSITION SENSOR

(71) Applicant: MANDO CORPORATION, Pyeongtaek-si (KR)

(72) Inventor: Seung Gyu Hong, Bucheon-si (KR)

(73) Assignee: MANDO CORPORATION, Pyeongtaek-si (KR)

(21) Appl. No.: 14/288,847

(22) Filed: May 28, 2014

(30) Foreign Application Priority Data
May 28, 2013 (KR) 10-2013-0060329

(51) Int. Cl. B62D 5/04

(52) U.S. Cl. CPC B62D 5/0484
USPC 701/41

(57) ABSTRACT

The present invention relates to a steering control method and a steering control apparatus for controlling steering when a failure occurs in a motor position sensor. In particular, the present invention relates to a steering control method and a steering apparatus, in which, when a failure occurs in a motor position sensor of a vehicle which is traveling according to an automatic traveling control, the traveling state of the vehicle is determined so as to determine whether it is a situation where a steering angle should be fixed, then a steering angle fixing control is performed according to the determination result, and, when it is determined that the driver has a will to steer, the steering angle fixing control is stopped such that the travel of the vehicle may be controlled according to the driver's steering.

### CROSS-REFERENCE TO RELATED APPLICATION

This application claims priority from and the benefit under 35 U.S.C. §119(a) of Korean Patent Application No. 10-2013-0060329, filed on May 28, 2013, which is hereby incorporated by reference for all purposes as if fully set forth herein.

### BACKGROUND OF THE INVENTION

1. Field of the Invention

The present invention relates to a steering control method and a steering control apparatus for controlling steering when a failure occurs in a motor position sensor.

2. Description of the Prior Art

Automatic travelling technologies of a vehicle have been actively researched since the late 1990s. According to such an automatic travelling technology, a vehicle may be made to travel to a destination without relying on a driver's steering but with the help of various sensors installed inside and outside of the vehicle, an electronic map input to a computer, and a Global Positioning System (GPS) using a satellite.

In particular, during automatic travel of the vehicle, the vehicle is supplied with a steering force only from a steering force supply apparatus equipped in the vehicle such as an electric motor, rather than being controlled by the driver's steering force.

Accordingly, such an automatic travel vehicle has a problem in that the driver's attentiveness is considerably lowered during traveling since the driver is not involved in steering the vehicle.

When a failure occurs in a motor position sensor for a motor that supplies the steering force for the automatically traveling vehicle under the situation where the driver's attentiveness is lowered, a problem may be caused in steering control of the vehicle according to the automatic travel. In such a case, there is a problem in that, since the driver cannot immediately respond to the situation, it may lead to a major accident.

Despite such problems, a steering control method for ensuring safe travel when a failure occurs in a motor position sensor of a vehicle which is traveling according to an automatic traveling control has not been provided.

### SUMMARY OF THE INVENTION

In this background, an aspect of the present invention is to provide a steering control method, in which, when a failure occurs in a motor position sensor of a vehicle which is traveling according to an automatic traveling control, the traveling state of the vehicle is determined so as to determine whether it is a situation where a steering angle should be fixed, then a steering angle fixing control is performed according to the determination result, and, when it is determined that the driver has a will to steer the vehicle, the steering angle fixing control is stopped so that the vehicle may be controlled to travel according to the driver's steering.

In accordance with an aspect of the present invention, there is provided a steering control apparatus including: a failure determination unit configured to determine whether a failure occurs in a motor position sensor that detects a rotation position of a rotor of a motor which supplies a steering force for a vehicle which is traveling according to an automatic traveling control; a vehicle traveling state determination unit configured to determine the traveling state of the vehicle so as to determine whether a steering angle should be fixed when it is determined that a failure occurs in the motor position sensor; a steering angle fixing control unit configured to perform a steering angle fixing control so as to fix the steering angle by controlling the driving of the motor when it is determined that it is a situation where the steering angle should be fixed; and a vehicle control unit configured to determine whether a driver has a will to steer and, when it is determined that the driver has the will to steer, to perform a control so as to stop the steering angle fixing control such that the vehicle travels based on the driver's steering.

In accordance with another aspect of the present invention, there is provided a steering control method including: a failure determination step of determining whether a failure occurs in a motor position sensor that detects a rotation position of a rotor of a motor which supplies a steering force for a vehicle which is traveling according to an automatic traveling control; a vehicle traveling state determination step of determining the traveling state of the vehicle so as to determine whether it is a situation where a steering angle should be fixed when it is determined that a failure occurs in the motor position sensor; a steering angle fixing control step of performing a steering angle fixing control so as to fix the steering angle by controlling the driving of the motor when it is determined that it is the situation where the steering angle should be fixed; and a vehicle control step of determining whether a driver has a will to steer and, when it is determined that the driver has the will to steer, performing a control so as to stop the steering angle fixing control such that the vehicle travels based on the driver's steering.

According to the present invention as described above, when a failure occurs in a motor position sensor of a vehicle which is traveling according to an automatic traveling control, it is possible to determine the traveling state of the vehicle so as to determine whether it is a situation where a steering angle should be fixed. According to the determination result, a steering angle fixing control may be performed and, when it is determined that the driver has a will to steer, the steering angle fixing control may be stopped such that the vehicle may be controlled to travel according to the driver's steering.

In addition, according to the present invention, even if a failure has occurred in the motor position sensor for the motor that supplies a steering force for an automatically traveling vehicle, the steering angle may be fixed until the driver recognizes the failure and performs a steering control for the vehicle. As a result, even in a situation where the driver's attentiveness is lowered, it is possible to prevent an accident such as deviation of the traveling vehicle from a traveling path.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram of a steering control apparatus according to an exemplary embodiment of the present invention;

FIG. 2 is a view exemplifying that a vehicle traveling state determination unit according to an exemplary embodiment of the present invention receives an input of information from a sensor so as to determine whether to turn a vehicle or not;

FIG. 3 is a view specifically illustrating that the vehicle traveling state determination unit according to the exemplary embodiment of the present invention determines whether it is a situation where a steering angle should be fixed;

FIGS. 4A and 4B are views exemplifying the traveling of a vehicle during turning before and after performing a steering angle fixing control by the steering control apparatus according to the exemplary embodiment of the present invention;

FIGS. 5A and 5B are views exemplifying that the vehicle control unit according to the exemplary embodiment of the present invention determines whether a driver has a will to steer;

FIG. 6 is a flowchart of a steering control method according to an exemplary embodiment of the present invention; and

FIG. 7 is a flowchart illustrating the steering control method according to the exemplary embodiment of the present invention in more detail.

### DETAILED DESCRIPTION OF THE EXEMPLARY EMBODIMENTS

The present invention discloses a steering control apparatus and a steering control method for securing traveling stability of a vehicle when a failure occurs in a motor position sensor of the vehicle while the vehicle is traveling according to an automatic travel control.

Hereinafter, a steering control apparatus and a steering control method according to an exemplary embodiment of the present invention will be described with reference to the accompanying drawings.

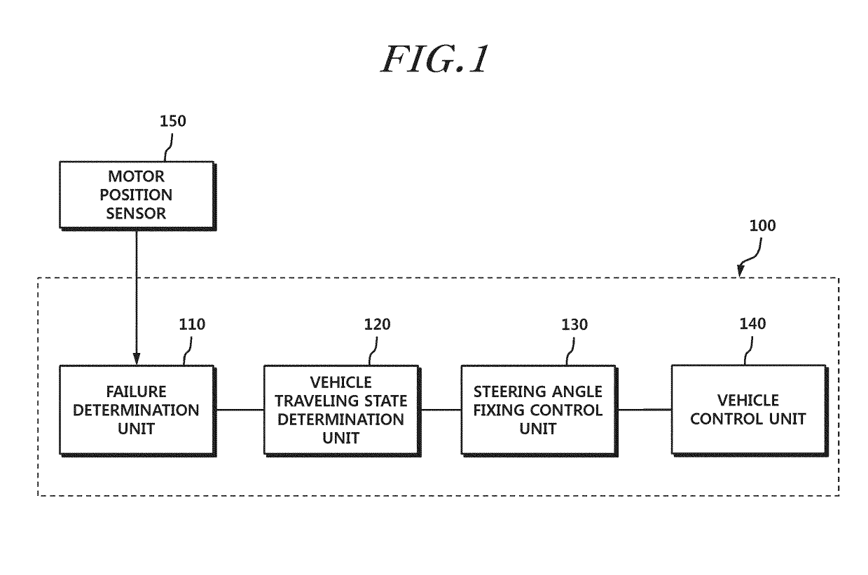

FIG. 1 is a block diagram of a steering control apparatus 100 according to an exemplary embodiment of the present invention.

A steering control apparatus 100 according to an exemplary embodiment of the present invention may include: a failure determination unit 110 configured to determine whether a failure occurs in a motor position sensor 150 that detects a rotation position of a rotor of a motor which supplies a steering force for a vehicle which is traveling according to an automatic traveling control; a vehicle traveling state determination unit 120 configured to determine the traveling state of the vehicle so as to determine whether a steering angle should be fixed when it is determined that a failure occurs in the motor position sensor; a steering angle fixing control unit 130 configured to perform a steering angle fixing control so as to fix the steering angle by controlling the driving of the motor when it is determined that it is a situation where the steering angle should be fixed; and a vehicle control unit 140 configured to determine whether a driver has a will to steer and, when it is determined that the driver has the will to steer, to to stop the steering angle fixing control and perform a control such that the vehicle travels based on the driver's steering.

The above-described automatic travel may refer to making a vehicle travel to a destination using various sensors of the vehicle and a GPS rather than relying on a driver's steering and may be understood as a general meaning that includes automatic travel in which the driver does not control steering and vehicle speed and automatic steering in which steering is automatically performed and the driver controls vehicle speed only.

Descriptions will be made in more detail with reference to FIG. 1. The failure determination unit 110 may determine whether a failure occurs in a motor position sensor 150 that detects a rotation position of a rotor of a motor that supplies a steering force for a vehicle which is traveling according to an automatic traveling control. The failure determination unit 110 may determine whether the failure occurs by receiving a signal indicating whether a failure occurs from the motor position sensor 150 that measures the position of the rotor of the motor.

For example, the failure determination unit 110 may determine a failure has occurred in the motor position sensor when the motor position sensor cannot detect the position of the rotor of the motor or cannot detect a positional change of the rotor even if the actual position of the rotor has changed.

In addition, when the failure has occurred in the above-described motor position sensor, for example, the vehicle traveling state determination unit 120 may determine whether it is a situation where the steering angle at the time of determining the failure occurrence should be fixed based on the travel state of the vehicle.

When the failure has occurred in the position sensor and it is a situation where the steering angle should be fixed, the steering angle fixing control unit 130 may perform a steering angle fixing control so at to fix the steering angle to the steering angle at the time of determining the failure occurrence. Alternatively, when the failure has occurred in the motor position sensor and it is the situation where the steering angle should be fixed, the steering angle fixing control unit 130 may perform the steering angle fixing control so as to fix the steering angle to a specific steering angle.

For example, in order to fix the steering angle, the steering angle fixing control unit 130 may fix the steering angle by controlling an apparatus engaged with a steering wheel or a steering shaft to fix the steering angle or by performing a control such that the rotation shaft of the motor is fixed without being rotated.

When the steering angle is fixed, the vehicle control unit 140 may determine whether the driver has a will to steer, and when it is determined that the driver has the will to steer, the vehicle control unit 140 may stop the steering angle fixing control and interrupt the supply of the steering force from the motor that supplies the steering force such that the vehicle may be controlled to travel by the driver's steering.

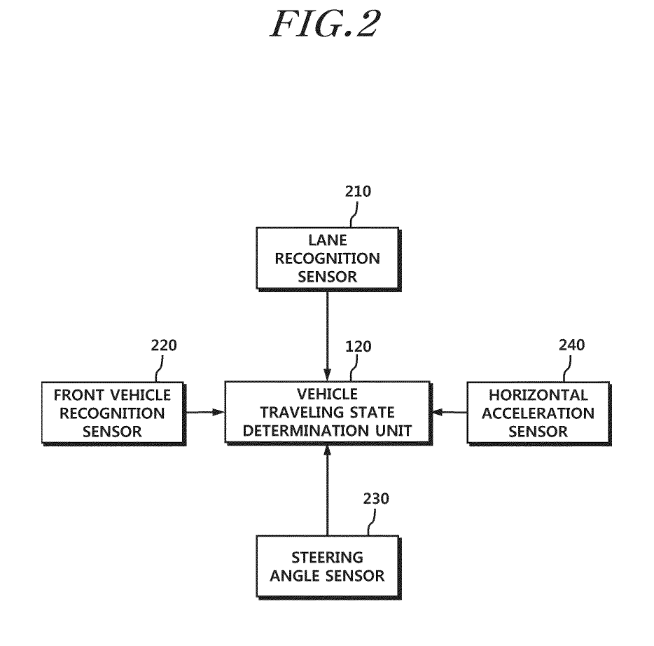

FIG. 2 is a view exemplifying that the vehicle traveling state determination unit 120 according to the exemplary embodiment of the present invention receives information from sensors so as to determine whether the vehicle is being turned.

When it is determined that the traveling vehicle is being turned, the vehicle traveling state determination unit 120 according to an exemplary embodiment of the present invention may determine that it is a situation where the steering angle should be fixed.

In addition, the vehicle traveling state determination unit 120 according to the exemplary embodiment of the present invention may determine whether the traveling vehicle is turned according to an automatic traveling control based on information input from one or more sensors selected from a lane recognition sensor 210, a front vehicle recognition sensor 220, a steering angle sensor 230, and a horizontal acceleration sensor 240.

A specific example will be described with reference to FIG. 2. When a failure occurs in a motor position sensor of a vehicle which is traveling according to an automatic traveling control, the vehicle traveling state determination unit 120 may determine whether to fix the steering angle at the time of failure determination of the motor position sensor. Alternatively, the vehicle traveling state determination unit 120 may determine whether to fix the steering angle to a specific steering angle or a steering angle obtained through calculation.

For example, when the failure occurs in the motor position sensor of the vehicle traveling according to an automatic traveling control during traveling of the vehicle on a curve, the vehicle traveling state determination unit 120 may determine that it is a situation where the steering angle should be fixed.

For example, the vehicle traveling state determination unit 120 may receive information from one or more sensors selected from the lane recognition sensor 210 configured to recognize a lane of a traveling path, the front vehicle recognition sensor 220 configured to recognize a vehicle in front and trace the movement of the vehicle in front, the steering angle sensor 230 configured to measure the steering angle of the vehicle, and the horizontal acceleration sensor 240 configured to measure a horizontal acceleration occurring during traveling of the vehicle on a curve so as to determine whether the vehicle is being turned based on the information.

Specifically, the vehicle traveling state determination unit 120 may measure a curvature of a lane based on the information input from the lane recognition sensor 210 and, when the lane has a curvature or when the measured curvature is equal to or larger than a pre-set reference value, the vehicle traveling state determination unit 120 may determine that the vehicle is being turned.

In addition, the vehicle traveling state determination unit 120 may receive information for the movement of the vehicle in front from the front vehicle recognition sensor 220, and when the front vehicle is traveling on a curve, the vehicle traveling state determination unit 120 may determine that the vehicle which is traveling according to the automatic traveling control is being turned.

In addition, the vehicle traveling state determination unit 120 may receive steering angle information of the vehicle traveling according to the automatic traveling control, which is input from the steering angle sensor 230, and compare the input steering angle information with a pre-set reference value. And when the input steering angle information is equal to or larger than the pre-set reference value, the vehicle traveling state determination unit 120 may determine that the vehicle is being turned.

The vehicle traveling state determination unit 120 may determine whether the vehicle is being turned based on information input from any one of the above-described sensors. Alternatively, the vehicle traveling state determination unit 120 may determine whether the vehicle is being turned based on all the information input from each of the sensors. Further, after determining whether the vehicle is being turned based on the information input from each sensor, the vehicle traveling state determination unit 120 may collect the information used for determination so as to finally determine that the vehicle is being turned.

For example, when it is not a situation where the steering angle should be fixed, the vehicle traveling state determination unit 120 performs a control such that the steering angle control according to the automatic traveling control is stopped to terminate the automatic traveling control as well as to interrupt supply of the auxiliary steering force from the motor or the like so that the traveling control of the vehicle may be performed by the driver's steering force and steering information.

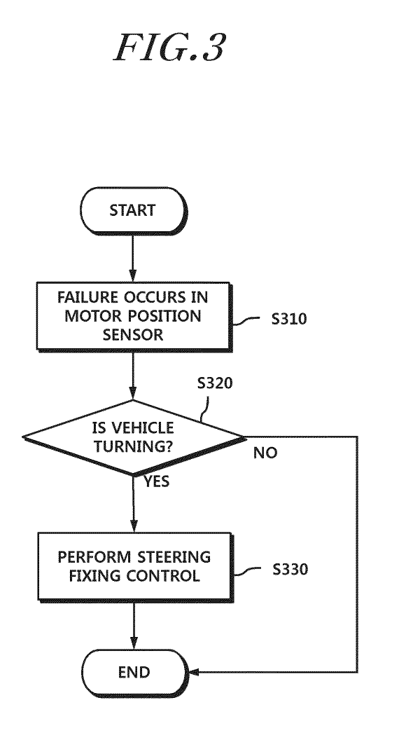

FIG. 3 is a view illustrating in detail that the vehicle traveling state determination unit 120 according to the exemplary embodiment of the present invention determines whether it is a situation where the steering angle should be fixed.

Referring to FIG. 3, when a failure occurs in the motor position sensor of a vehicle (S310), the vehicle traveling state determination unit 120 determines whether it is the situation where the steering angle should be fixed determined based on whether the vehicle is being turned (S320).

When it is determined that the vehicle is being turned, the vehicle traveling state determination unit 120 determines that it is the situation where the steering angle of the vehicle should be fixed, and the steering angle fixing unit 130 controls the driving of the motor such that the steering angle of the vehicle is fixed (S330).

When it is determined that the vehicle is not being turned, the vehicle traveling state determination unit 120 may determine that it is not the situation where the steering angle of the vehicle should be fixed, and perform a control to interrupt the supply of the steering force from the motor and terminate the automatic traveling control so that the traveling control of the vehicle may be performed by the driver's steering force and steering input.

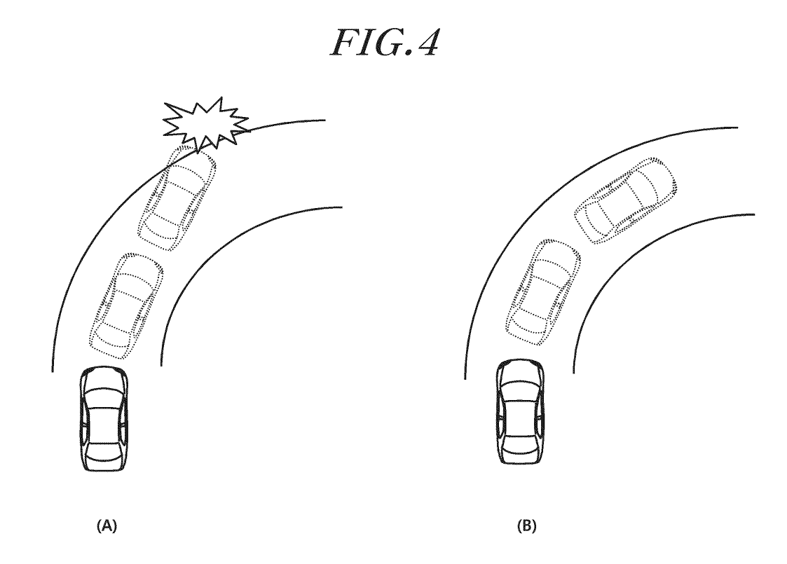

FIGS. 4A and 4B are views exemplifying traveling of a vehicle on a curve before (FIG. 4A) and after (FIG. 4B) performing a steering angle fixing control by the steering control apparatus according to the exemplary embodiment of the present invention.

For example, when the vehicle is traveling according to the automatic traveling control and a failure occurs in the motor position sensor while the vehicle is traveling on a curve as illustrated in FIG. 4A, supply of a steering force according to the automatic traveling control may not be normally performed and vehicle tires may be aligned in the longitudinal direction of the vehicle by the restoration torque of the vehicle tires such that the vehicle goes straight without being turned, thereby causing a problem such as deviation of the traveling vehicle from the traveling path.

The above-described restoration torque refers to a force to make the tires be aligned in the longitudinal direction of the vehicle which is traveling on a curve due to a torque generated in a direction to reduce a slip angle around a ground contact center of each tire since a point of application of a cornering force when the tire rotates with the slip angle does not coincide with the ground contact center.

Accordingly, as can be seen from FIG. 4A, there may be a problem in that since the driver does not perform steering during the traveling of the vehicle according to the automatic traveling control, an accident of deviation of the traveling vehicle from the traveling path may occur since the tires are aligned by the restoration torque of the tires during the period lasting until the driver recognizes the failure occurring in the vehicle and performs steering.

Referring to FIG. 4B, for example, when the failure has occurred in the motor position sensor of the vehicle, even if the the vehicle steering control according to the automatic traveling control is stopped, the steering control apparatus 100 fixes the steering angle so as to prevent straight traveling of the vehicle by the restoration torque of the tires such that the vehicle may safely travel without deviating from the traveling path until the driver performs steering.

When it is not the status where the above-described steering angle should be fixed since the vehicle is traveling a straight traveling path, the restoration torque of the tires is not generated even if the steering angle is not fixed. Thus, the deviation of the vehicle from the traveling path is not caused.

Hereinafter, detailed descriptions will be made on how the steering angle is fixed when the steering angle fixing control unit 130 according to the present invention performs the steering angle fixing control so as to fix the steering angle.

The steering angle fixing control unit 130 according to the exemplary embodiment of the present invention may control the rotation shaft of the motor to be fixed so as to perform the steering angle fixing control such that the steering angle may be fixed.

That is, for example, the steering angle fixing control unit 130 may perform the steering angle fixing control such that the steering angle is fixed. For example, for a vehicle which is turning, the steering angle fixing control unit 130 may fix the steering angle such that the steering wheel is maintained in a state where it is rotated by a predetermined portion according to, for example, a rotation radius.

Specifically, the steering angle fixing control unit 130 may open a power supply connected to three phases of the motor that supplies a steering force for the vehicle and electrically shorts the three phases of the motor to restrain the rotation shaft of the motor such that the steering angle can be fixed.

That is, in the case of a three phase motor, three high side Field Effect Transistors (FETs) may exist between the power supply and the motor, and three low side FETs may exist between the motor and a ground (earth).

In such a case, in order to fix the steering angle, the steering angle fixing control unit 130 turns ON the low side FETs between the motor and the ground so as to short the three phases, thereby restraining the rotation shaft of the motor to be in an electrically set-in state. As a result, the rotation shaft of the motor can be fixed.

Here, FET is an example of a circuit element which may serve as a switch through turn-on and turn-off operations. When the low side FETs are turned ON, the three phases of the motor are electrically shorted so that the rotation shaft can be fixed.

Now, a case in which the motor is connected with the steering shaft so as to transfer the steering force will be described as an example. When the rotation shaft of the motor is fixed, a reducer (constituted with a worm gear and a worm wheel and physically engaged with the rotation shaft of the motor to transfer the rotation force of the motor to the steering shaft) is also restrained and fixed so as not to be rotated. Accordingly, when the motor is fixed, the reducer is fixed and the steering shaft engaged with the reducer is also fixed. As a result, the steering angle can be fixed.

The foregoing descriptions may also be applied to a case where the motor supplies the steering force to a rack bar through a steering force transfer apparatus such as a belt. Even in the case in which the steering force is transferred from the motor to the rack bar, a control may be performed such that the steering angle is fixed by fixing the rotation shaft of the motor.

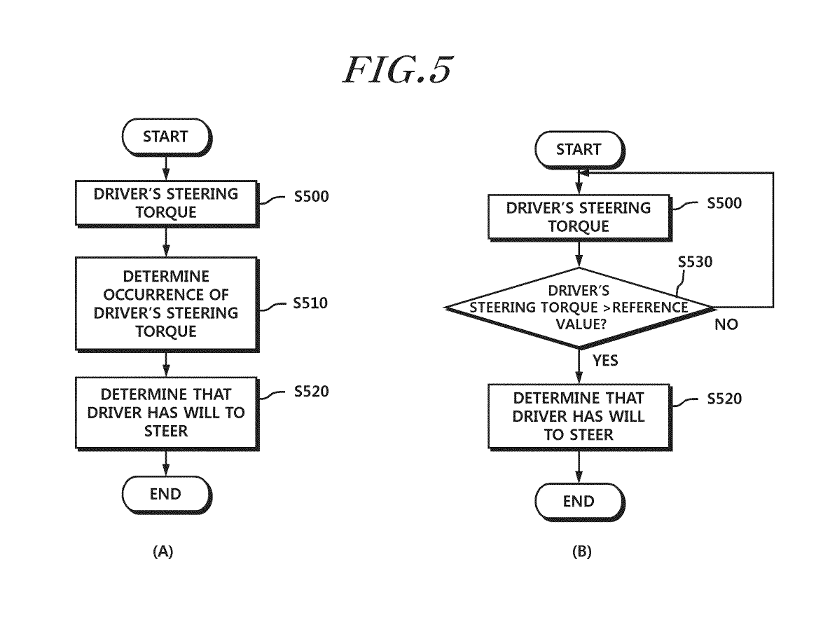

FIGS. 5A and 5B are views exemplifying that the vehicle control unit 140 according to the exemplary embodiment of the present invention determines whether a driver has a will to steer.

When a driver's steering torque is generated according to the driver's operation of the steering wheel, the vehicle control unit 140 according to the exemplary embodiment of the present invention may determine that the driver has a will to steer (S510, S520). Alternatively, the vehicle control unit 140 may compare the driver's steering torque and a reference torque value. Then, when the driver's steering torque is equal to or larger than the reference torque value, the vehicle control unit 140 may determine that the driver has a will to steer (S530, S520).

Referring to FIG. 5A, for example, the vehicle control unit 140 may receive steering torque information In order to determine whether the driver has a will to steer, and when it is determined that the driver's steering torque is generated, the vehicle control unit 140 may determine that the driver has a will to steer (S500, S510, S520).

Referring to FIG. 5B, for example, the vehicle control unit 140 may receive an input of the driver's steering torque information and compare the driver's steering torque with a pre-set reference torque value in order to determine whether the driver has a will to steer. When the driver's steering torque is equal to or larger than the reference torque value, the vehicle control unit 140 may determine that the driver has a will to steer. When the driver's steering torque is less than the reference torque value, the vehicle control unit 140 may determine that the driver does not have the will o steer and may receive an input of a new driver's steering torque so as to repeatedly determine whether the driver has a will to steer (S500, S530, S520).

For example, the vehicle control unit 140 may receive an input of the driver's steering torque from a torque sensor and/or a torque angle sensor, which are capable of measuring the driver's steering torque so as to determine whether the driver has a will to steer (S520). Alternatively, the vehicle control unit 140 may compare the driver's steering torque with a pre-set reference torque and determine whether the driver has a will to steer according to the comparison result (S530).

The reference torque value compared to the driver's steering torque so as to determine whether the driver has a will to steer may be set to a minimum steering torque value through a test or the like which enables determination as to whether the driver has a will to steer in the state where the steering angle is fixed.

Even in the state where the steering angle is fixed, the driver's steering torque may be measured through the torsion of a torsion bar when the driver manipulates the steering wheel to generate the steering force on the input shaft of the steering shaft. This is because a steering force supply apparatus that supplies the steering force, such as an electric steering motor, is engaged with the output shaft of the steering shaft to fix the output shaft of the steering shaft.

When it is determined that the driver has a will to steer (S520), the vehicle control unit 140 according to the exemplary embodiment of the present disclosure may perform a control such that the traveling control according to the automatic traveling control is terminated and the vehicle travels based on the driver's steering information.

For example, when it is determined that the driver has a will to steer, the vehicle control unit 140 may perform a control such that the steering angle fixing control is stopped, the steering force of the motor where the failure has occurred is interrupted to terminate the traveling control according to the automatic traveling control, and the automatic traveling state is changed to a manual traveling state in which the vehicle travels according to the driver's steering information.

Hereinafter, a steering control method according to another exemplary embodiment of the present invention which has been described above with reference to FIGS. 1 to 5 will be briefly described again.

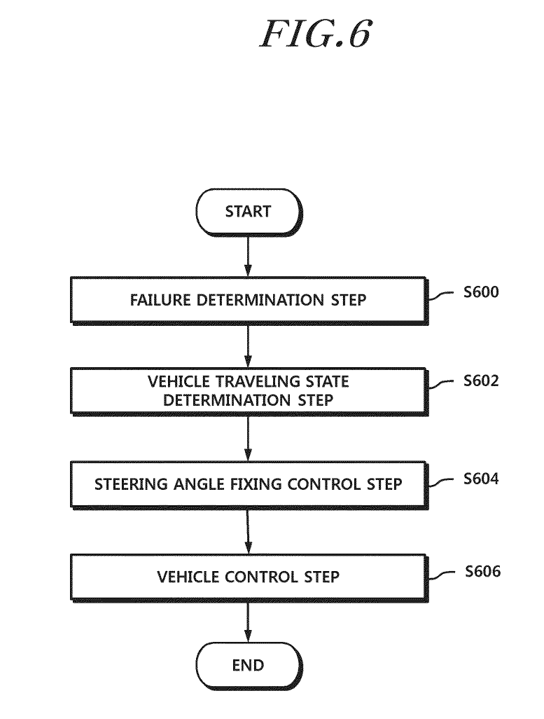

FIG. 6 is a flowchart of a steering control method according to another exemplary embodiment of the present invention.

The steering control method according to another exemplary embodiment of the present invention may include: a failure determination step of determining whether a failure occurs in a motor position sensor that detects a rotation position of a rotor of a motor which supplies a steering force for a vehicle which is traveling according to an automatic traveling control (S600); a vehicle traveling state determination step of determining the traveling state of the vehicle so as to determine whether it is a situation where a steering angle should be fixed when it is determined that a failure occurs in the motor position sensor (S602); a steering angle fixing control step of performing a steering angle fixing control so as to fix the steering angle by controlling the driving of the motor when it is the situation where the steering angle should be fixed (S604); and a vehicle control step of determining whether a driver has a will to steer and, when it is determined that the driver has the will to steer, performing a control so as to stop the steering angle fixing control such that the vehicle travels based on the driver's steering.

Descriptions will be made referring to FIG. 6 by way of an example. The steering control method may include determining whether a failure occurs in a motor position sensor that detects a rotation position of a rotor of a motor which supplies a steering force for a vehicle which is traveling according to an automatic traveling control (S600). In addition, the steering control method may include determining whether it is a situation where a steering angle should be fixed when it is determined that a failure occurs in the motor position sensor (S602). When it is determined that it is the situation where the steering angle should be fixed as in a case where the vehicle is turning, the steering control method may further include performing a steering angle fixing control such that the steering angle is fixed (S604). Further, the steering control method may further include determining whether a driver has a will to steer and, according to the determination result, performing a control so as to stop the steering angle fixing control such that the vehicle travels based on the driver's steering (S606).

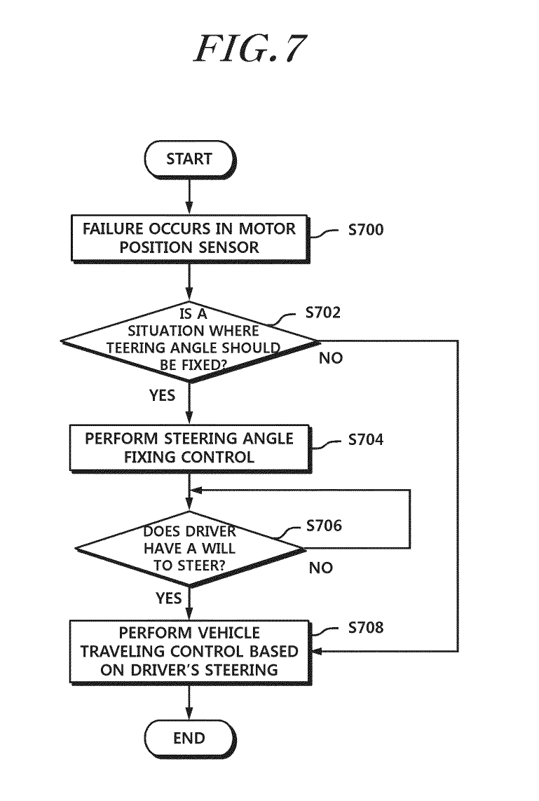

FIG. 7 is a flowchart illustrating the steering control method according to another exemplary embodiment of the present invention in more detail.

Descriptions will be made in detail with reference to FIG. 7. In the failure determination step (S600), it may be determined whether a failure of the motor position sensor occurs (S700).

In addition, in the vehicle traveling state determination step (S602), when it is determined that the failure has occurred in the motor position sensor of the vehicle which is traveling according to the automatic traveling control, it may be determined whether it is a situation where the steering angle should be fixed (S702). For example, the determination as to whether it is a situation where the steering angle should be fixed at the time of failure occurrence may be made depending on whether the vehicle is turning or not.

When it is the situation where the steering angle should be fixed, the steering angle fixing control step (S604) may perform a steering angle fixing control so as to control the driving of the motor such that the steering angle is fixed (S704). For example, a control may be performed such that three phases of the electric steering motor are electrically shorted to fix the rotation shaft of the motor. When it is not the situation in which the steering angle should be fixed, a control may be performed such that the vehicle is traveled according to the driver's steering information (S708).

In the vehicle control step (S606), in the state where the steering angle is fixed, it is determined so as to determine whether the driver has recognized that the failure of the motor position sensor has occurred and whether the driver has initiated steering so as to determine whether the driver has a will to steer (S706). For example, it is possible to determine whether the driver has a will to steer may be determined based on the driver's steering torque measured by the steering torque sensor as described above (S706).

When the driver's will to steer is not sensed, the steering angle may be fixed and the driver's will to steer may be repeatedly checked (S706).

In the vehicle control step (S606), when it is determined that the driver has a will to steer, the traveling control according to the automatic traveling control may be terminated and the vehicle may travel according to the driver's steering information (S708). In such a case, supply of the steering force of the failed motor may be interrupted such that the vehicle may travel based on the driver's steering force and steering information.

As described above, according to the present invention, when a failure occurs in a motor position sensor of a vehicle which is traveling according to an automatic traveling control, it is possible to determine the traveling state of the vehicle so as to determine whether it is a situation where a steering angle should be fixed. According to the determination result, a steering angle fixing control may be performed and, when it is determined that the driver has a will to steer, the steering angle fixing control may be stopped such that the the vehicle may be controlled to travel according to the driver's steering.

In addition, according to the present invention, even if a failure has occurred in the motor position sensor for the motor that supplies a steering force for an automatically traveling vehicle, the steering angle may be fixed until the driver recognizes the failure and performs a steering control for the vehicle. As a result, even in a situation where the driver's attentiveness is lowered, it is possible to prevent an accident such as deviation of the traveling vehicle from a traveling path.

What is claimed is:

1. A steering control apparatus comprising:
a failure determination unit configured to determine whether a failure occurs in a motor position sensor that detects a rotation position of a rotor of a motor which supplies a steering force for a vehicle which is traveling according to an automatic traveling control;
a vehicle traveling state determination unit configured to determine the traveling state of the vehicle so as to determine whether a steering angle should be fixed when it is determined that a failure occurs in the motor position sensor;
a steering angle fixing control unit configured to perform a steering angle fixing control so as to fix the steering angle by controlling the driving of the motor when it is determined that it is a situation where the steering angle should be fixed; and
a vehicle control unit configured to determine whether a driver has a will to steer and, when it is determined that the driver has a will to steer, to perform a control so as to stop the steering angle fixing control such that the vehicle travels based on the driver's steering.

2. The steering control apparatus of claim 1, wherein, as to the traveling state, when it is determined that the vehicle is turning, the vehicle traveling state determination unit determines that it is the situation in which the steering angle should be fixed.

3. The steering control apparatus of claim 2, wherein the vehicle traveling state determination unit determines that as to the traveling state, the vehicle is turning based on information input from one or more sensors selected from a lane recognition sensor, a front vehicle recognition sensor, a steering angle sensor, and a horizontal acceleration sensor.

4. The steering control apparatus of claim 1, wherein the steering angle fixing control unit performs the steering angle fixing control such that the steering angle is fixed by controlling the rotation shaft of the motor to be fixed.

5. The steering control apparatus of claim 1, wherein, when a driver's steering torque is generated according to the driver's manipulation of the steering wheel or when the driver's steering torque is compared with a reference torque value and the driver's steering torque is equal to or larger than the reference torque value, the vehicle control unit determines that the driver has a will to steer.

6. The steering control apparatus of claim 1, wherein, when it is determined that the driver has a will to steer, the vehicle control unit performs a control such that the traveling control according to the automatic traveling control is terminated and the vehicle travels based on the driver's steering information.

7. A steering control method comprising:
a failure determination step of determining whether a failure occurs in a motor position sensor that detects a rotation position of a rotor of a motor which supplies a steering force for a vehicle which is traveling according to an automatic traveling control;
a vehicle traveling state determination step of determining the traveling state of the vehicle so as to determine whether it is a situation where a steering angle should be fixed when it is determined that a failure occurs in the motor position sensor;
a steering angle fixing control step of performing a steering angle fixing control so as to fix the steering angle by controlling the driving of the motor when it is determined that it is the situation where the steering angle should be fixed; and
a vehicle control step of determining whether a driver has a will to steering and, when it is determined that the driver has a will to steer, performing a control so as to stop the steering angle fixing control such that the vehicle travels based on the driver's steering.
